(19) United States
(12) Patent Application Publication
(10) Pub. No.: US 2026/0041268 A1
(43) Pub. Date: Feb. 12, 2026

(54) AUTONOMOUS DUAL POT SYNCHRONOUS COOKING APPARATUS

(71) Applicants: Chaitanya Kiran Alla, Avenel, NJ (US); Abhinav Modugula, Ellicott City, MD (US); Abhijit Vasili, Riverview, FL (US)

(72) Inventors: Chaitanya Kiran Alla, Avenel, NJ (US); Abhinav Modugula, Ellicott City, MD (US); Abhijit Vasili, Riverview, FL (US)

(21) Appl. No.: 18/798,098

(22) Filed: Aug. 8, 2024

(51) Int. Cl. A47J 27/12; A47J 27/00; A47J 36/16

(52) U.S. Cl. CPC A47J 27/12; A47J 27/002; A47J 36/165

(57) ABSTRACT

An autonomous dual pot cooking apparatus includes two cooking mechanisms with two cooking vessels disposed within a cooking drawer. The first cooking vessel includes a hinged strainer tool that holds ingredients and transfers them to the second cooking vessel, which includes a stirring tool for mixing ingredients. The apparatus includes containers to hold and transfer ingredients necessary for cooking into either or both cooking vessels. The apparatus is part of an autonomous system including a computing device and application for instructing the apparatus to cook according to a selected recipe.

### BACKGROUND OF THE INVENTION

The present invention relates to cooking apparatuses, and, more particularly, to an autonomous dual pot cooking apparatus configured to perform synchronous cooking of separate meal ingredients.

Traditionally, cooking is a time-consuming task that results in meals of variable quality due in part to differing methods and techniques for cooking carbohydrates such as vegetables and starches as opposed to proteins, such as animal meats. Additionally, human control of portions for additives such as spices and fats contribute to variability in taste and subsequent perception of quality. Prior art autonomous cooking systems focus only on one macronutrient type, often require additional ingredients to be precooked when placed into the system, and do not control portion measurements for food additives, such as spices and fats. These systems do not resolve the time inefficiencies of traditional cooking as time is still spent pre-cooking certain ingredients to place into the system. Furthermore, consistency concerns are not addressed as humans are still in charge of measuring portions for food additives.

As can be seen, there is a need for an autonomous dual pot cooking apparatus configured to cook different macronutrient sources in parallel and to control dispensing of food additives while cooking, increasing cooking efficiency and meal taste consistency.

### SUMMARY OF THE INVENTION

In one aspect of the present invention, an autonomous cooking apparatus, includes a housing, at least one memory, and at least one processor disposed within the housing, a graphical user interface disposed on the housing, a plurality of dispensers disposed in a plurality of apertures on the housing, and a cooking drawer slidably mounted to the housing. The cooking drawer includes a first cooking element, a first cooking vessel disposed on the first cooking element, a second cooking element, and a second cooking vessel disposed on the second cooking element. The first and second cooking elements may be any suitable type of cooking element known in the art. For example, the elements may be induction elements powered by a microcontroller.

Additionally, the autonomous cooking apparatus can include a strainer tool hingedly mounted to the second cooking vessel and disposed to over an opening of the first cooking vessel, and a stirring tool disposed on the second cooking vessel. A conveyor tool can be disposed within the housing and is configured to travel between a first subset of the plurality of dispensers.

In another aspect of the present invention, an autonomous cooking system is provided. The autonomous cooking system includes a computing device, running a software application where a user can select a recipe to be cooked by the autonomous cooking apparatus. Once selected, a recipe can be transmitted to the autonomous cooking apparatus, where the recipe is converted into instructions for actuating electromechanical systems of the autonomous cooking system for use in cooking.

These and other features, aspects and advantages of the present invention will become better understood with reference to the following drawings, description, and claims.

### BRIEF DESCRIPTION OF THE DRAWINGS

FIG. 1 is a front perspective view of an autonomous dual pot cooking apparatus, according to aspects of the present invention;

FIG. 2 is an exploded top perspective view thereof;

FIG. 3 is an exploded side perspective view thereof;

FIG. 4 is a detail perspective view thereof;

FIG. 5 is a block diagram of a system for operating the autonomous dual pot cooking apparatus of FIG. 1, according to aspects of the present invention; and

FIG. 6 is a flow chart of a process according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

A general overview of the various features of the invention will be provided, with a detailed description following. Broadly, one embodiment of the present invention is an autonomous dual pot cooking apparatus. The system disclosed herein operates in two stages, with two heating panels and two dishes or cooking vessels. The apparatus operates unidirectionally, transferring the contents of a first cooking vessel into a second cooking vessel at a selected intermediate cooking time.

The apparatus eliminates hands-on cooking and variability in food taste due to inconsistent use of ingredients, such as spice and fats, and the need to pre-cook portions of meals for inclusion in a larger recipe. The device may be set up to add recipe ingredients and once started requires no user intervention until cooking is completed.

In some embodiments, the system may have a starch cooking vessel having a strainer nested therein and a sauce cooking vessel with a motor-driven stirrer. The starch cooking vessel has a first heating element and the sauce vessel has a second heating element. The heating elements, the strainer, and the stirrer may be controlled by a microcontroller.

The system may also have ingredient vessels operative to dispense selected amounts of selected ingredients to each cooking vessel. Each of the ingredient vessels may have a dispensing means, such as a pump, an operational screw, and/or a valve, controlled by the microcontroller.

The system may comprise a housing that includes a cooking drawer, which houses two cooking mechanisms, such as induction cooking mechanisms, a first cooking vessel with a strainer attachment, a second cooking vessel with a stirring attachment, and a plurality of container vessels. The housing may generally have a bottom, side walls, and a top.

In embodiments, the present invention can include separate container vessels for each of a plurality of ingredients for cooking, such as but not limited to, oil container, water container, main ingredient container, secondary ingredients containers, spices containers, etc. In embodiments, a conveyor assembly can be provided to autonomously dispense spices from each of a plurality of spice containers.

In embodiments, actuatable valves can be disposed within liquid containers, such as a water and/or an oil container, to autonomously dispense liquid, as needed.

In embodiments, the autonomous cooking apparatus of the present invention includes electromechanical components, such as motors, valves, etc., that are actuatable under the control of an operating system, such as Robot Operating System (ROS), resident on a processing device in the apparatus. The processing device may in some cases be a microcontroller. For example, a Raspberry Pi® and/or ESP32™ microcontroller(s) may be used.

In some embodiments, the system may be operated remotely.

In some embodiments, the temperature of each heating element may be varied.

In some embodiments, any of the cooking vessels and/or the ingredient containers may be cylindrical.

Additional aspects of the present invention include a system for controlling synchronous cooking by the autonomous dual pot cooking apparatus. The system may include a computing device, such as a mobile smartphone, operating software, such as an application, that can select recipes from a datastore, such as a database. The selection of a recipe from the datastore can cause the operating system of the autonomous dual pot cooking apparatus to actuate electromechanical components of the apparatus to move, fill, or otherwise place ingredients into one of the two cooking vessels to perform cooking according to the selected recipe.

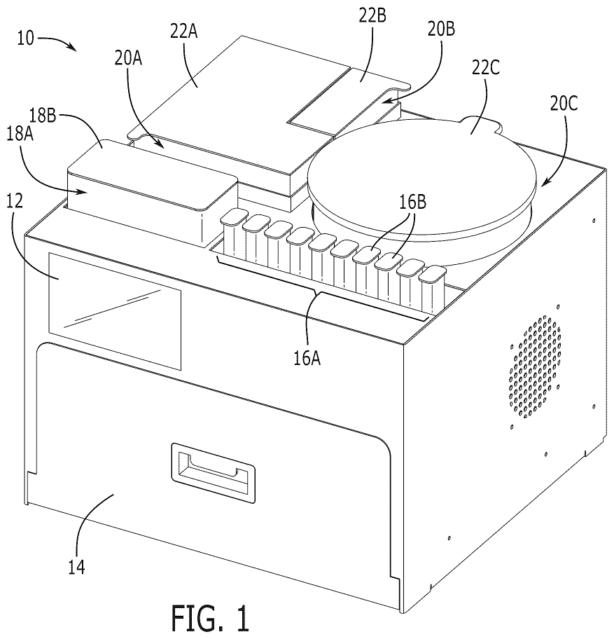

Referring to FIGS. 1-6, FIGS. 1-4 depict an autonomous dual pot cooking apparatus 10 according to an embodiment of the present invention. In FIG. 1, apparatus 10 can have a display screen 12 electronically communicating with a controller (not shown) and configured to display information related to a cooking operation. In embodiments, a display screen 12 can display cooking temperature, total cooking time, cooking time remaining, and/or any selectable options related to a cooking operation. A cooking drawer 14 can be disposed proximate to display screen 12 and is operative to house cooking elements, such as heating elements and cooking vessels. In embodiments, drawer 14 can be opened with a handle affixed thereto or otherwise positioned in an open configuration. A plurality of container vessels can be disposed, or seated, in apertures located about a top of apparatus 10 and are adapted to house ingredients used in autonomous cooking operations. In embodiments, the plurality of container vessels can include a plurality of spice containers 16A with lids 16B, a main ingredient container 18 with a lid 18B, a water container 20A with lid 22A, an oil container 20B with lid 22B, and a secondary ingredient container 20C with lid 22C. While containers are specifically described with respect to a preferred ingredient contained therein, it is understood that any, or all, of the plurality of containers can function to contain any ingredient without departing from the scope of the invention.

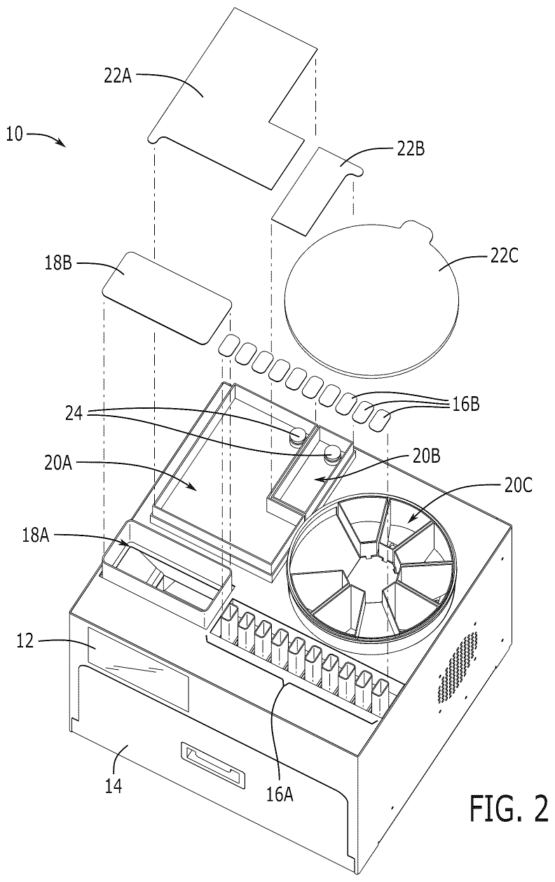

In FIG. 2, the plurality of containers 16A, 18A, and 20A-C are shown to have removable affixable lids 16B, 18B, 20A, and 20C respectively. Advantageously, lids 16B, 18B, and 22A-C can be removed so as not to interfere with ingredient addition and can be replaced during cooking operations to prevent cross contamination, spillage, or other messes. In embodiments, containers 20A, 20B, and 20C can be adapted to accept liquids or viscous materials, such as water or oil, and can have actuatable valves 24 installed within. In embodiments, valves 24 are actuatable to drain viscous materials from containers 20A-B. In embodiments, containers 20A-B can have variable depth and actuatable valves 24 (see FIG. 2) can be disposed at a portion of each container having a maximum depth, thereby allowing for maximum drainage of viscous materials. Container 20C can include a plurality of internal containers, which can be used to segregate ingredients. In embodiments, each internal container can contain the same, or different, ingredient to each other internal container, and/or each internal container can be segregated according to a serving size. Advantageously, internal containers can allow for a plurality of differing ingredients to be stored, eliminating the need to continually add ingredients to the apparatus 10. Additionally, internal containers can be adapted to receive an exact serving size, thereby providing consistency in dispensing of ingredients leading to greater consistency.

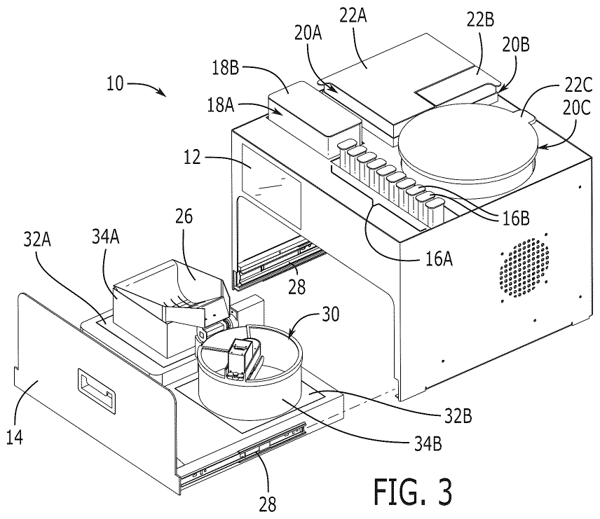

In FIG. 3, additional aspects of the cooking drawer 14 are illustrated. Drawer 14 can be slidably, or moveably, mounted to a housing of apparatus 10 by slider mechanism 28. In embodiments, slider mechanism 28 can be drawer slides, glides, or runners, and can advantageously be moveable to expose the internal components of drawer 14 for easy maintenance, repair, cleaning, removal, replacement, etc. Internal components of drawer 14 can include at least a first cooking mechanism 32A, a second cooking mechanism 32B, a first cooking vessel 34A, a second cooking vessel 34B, a strainer tool 26, and a stirring tool 30. In embodiments, first cooking mechanism 32A and second cooking mechanism 32B can be induction cookers but are not so limited. First cooking vessel 34A can be disposed on first cooking mechanism 32A and strainer tool 26 may be mounted hingedly therein, adapted to separate liquid and/or viscous ingredients from solid ingredients. Second cooking vessel 34B can be disposed in second cooking mechanism 32B and can include stirring tool 30 adapted to stir, or otherwise agitate, ingredients within cooking vessel 34B. In embodiments, stirring tool 30 can be an electromechanical device controlled by a processing device (not shown) resident on apparatus 10. Advantageously, drawer 14 and its internal components perform autonomous cooking according to instructions provided by the processing device, eliminating the need for human cooking.

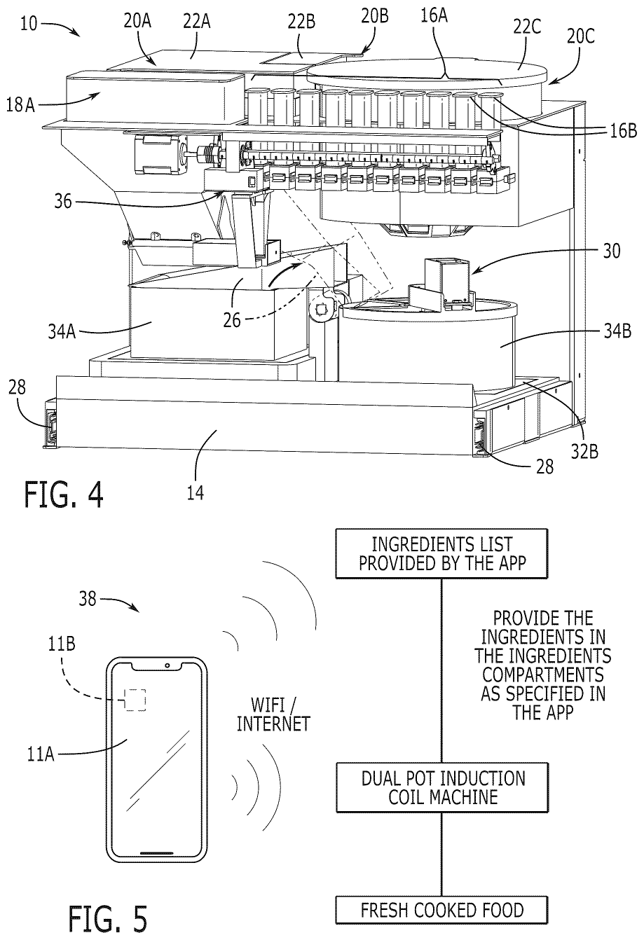

In FIG. 4, additional aspects of ingredient dispensing in apparatus 10 are illustrated. Referring to the cooking operation of first cooking mechanism 32A and first cooking vessel 34A, ingredients are dispensed from vessel 18A into strainer tool 26 disposed above first cooking vessel 34A. Fluid, such as water, is dispensed from container 20A through valve 24 into first cooking vessel 34A and/or second cooking vessel 34B. In embodiments, water is heated by first cooking mechanism 32A such that ingredients disposed within strainer tool 26 are cooked by boiling. Concurrently or independently, cooking fat such as oil can be dispensed from oil container 20B through valve 24 into first cooking vessel 34A and/or second cooking vessel 34B and ingredients from secondary ingredient container 20C are dispensed into second cooking vessel 34B. Additionally, necessary spices can each be dispensed from spice containers 16A into a motorized conveyor assembly 36, which can subsequently add the dispensed spices to the second cooking vessel 34B. In embodiments, the conveyor assembly 36 is electromechanically controllable by a processing device resident in apparatus 10 and is configured to move to each spice container 16A necessary to collect a spice and dispense the spice to second cooking vessel 34B before collecting and dispensing a next spice. Strainer tool 26 can be hingedly mounted to second cooking vessel 34B, and can be configured to dump, or otherwise transfer, ingredients from first cooking vessel 34A to second cooking vessel 34B. In embodiments, stirring tool 30, which may have a hanging mechanism, is electromechanically controllable by the processing device resident in apparatus 10, which can stir or mix ingredients as necessary. Advantageously, ingredient dispensing in apparatus 10 is controlled by a processing device resident in apparatus 10 and can ensure consistency in food taste and quality, while cooking without human intervention.

Referring to FIG. 5, aspects of a system for autonomous cooking 38 utilizing apparatus 10 are illustrated. A computing device 11A, such as a smartphone, can have a software application 11B installed and loaded thereon. A user can interact with application 11B to select from a datastore of recipes supported by application 11B. In embodiments, recipes are translated into instructions to command apparatus 10 to cook according to the requirements of each recipe. Once a recipe is selected by a user, instructions for cooking according to the recipe are transmitted to apparatus 10 by wireless communication. In embodiments, wireless communication can include any known means of wireless communication including, but not limited to, 802.11 wireless, Bluetooth®, near field communications, etc. User must supply ingredients for a selected recipe and place them into the appropriate container(s). In embodiments, spices can be continuously stored in spice containers 16A, while water, cooking fats, primary and secondary ingredients may generally be replaced before each use. Once ingredients are supplied, and the recipe instructions are transferred, apparatus 10 performs cooking of the recipe autonomously resulting in freshly cooked food. Advantageously, cooking in this manner saves time over manual cooking, and ensures consistent taste and quality of food produced.

A recipe built by a chef or user, e.g., in the mobile device, can be converted into machine executable instructions implemented by the system like building blocks. Each functional element of the machine generally has one or two operating parameters controlled by the system. For example, a stirrer may have a stirring time operating parameter. The oil dispenser may have as an operating parameter the quantity of oil to be dispensed. The secondary ingredient containers or compartments 20C may have instructions to open the container lid. The strainer may have an instruction activating its use. These machine executable instructions are implemented upon selection of a recipe by a user.

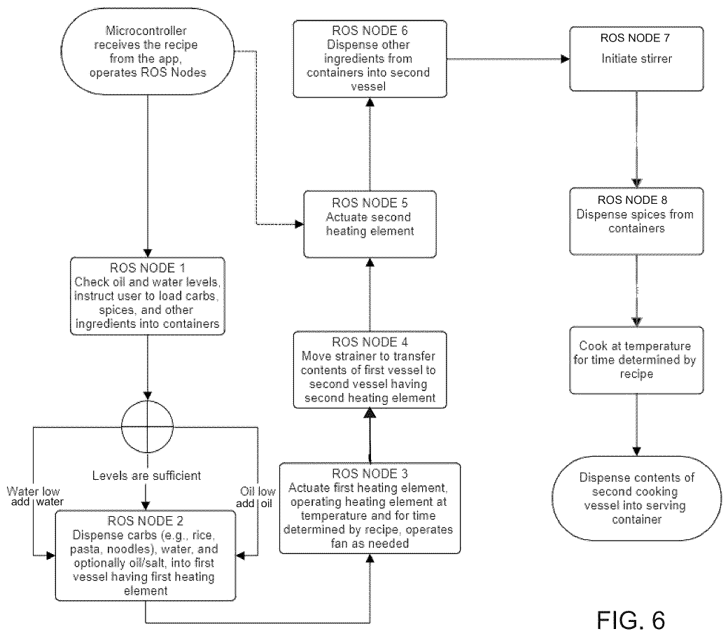

An exemplary process of cooking is outlined hereinafter and is not meant to be limiting. FIG. 6 illustrates a representative example thereof. In an exemplary process, a user chooses a pasta recipe from application 11B, and fills container 20A with water, 20B with oil, 18A with pasta, spice containers 16A with spices, and the plurality of containers in 20C with ingredients for making pasta sauce. Apparatus 10 begins by dispensing pasta from container 18A into strainer tool 26. Water is dispensed from container 20A, through valve 24, into first cooking vessel 34A. First cooking mechanism 32A heats water to boil pasta in strainer 26.

While pasta is boiling, oil is dispensed from container 20B, through valve 24 (see FIG. 2), into second cooking vessel 34B. Additionally, water is dispensed from container 20A, through valve 24, into second cooking vessel 34B, as required for pasta sauce. Second cooking mechanism 32B heats second cooking vessel 34B while ingredients from container 20C are dispensed into second cooking vessel 34B. Additionally, spices are dispensed into second cooking vessel 34B, as required by the recipe, by conveyor assembly 36. Once all ingredients are added to second cooking vessel 34B, stirring tool 30 mixes, or otherwise agitates, the ingredients.

In some embodiments, cooking of pasta sauce will commence, based on a total time to boil pasta, such that cooking of both dishes will complete substantially simultaneously.

Upon completion of pasta cooking, strainer tool 26 is actuated to transfer pasta into second cooking vessel 34B without human intervention. The transfer is unidirectional from the first cooking vessel 34A to the second cooking vessel 34B. Stirring tool 30 continues to mix, or otherwise agitate, added ingredient until cooking has completed. Once cooking is completed, second cooking vessel 34B can be removed to serve the completed dish.

It should be understood, of course, that the foregoing relates to exemplary embodiments of the invention and that modifications may be made without departing from the spirit and scope of the invention as set forth in the following claims.

What is claimed is:

1. An autonomous cooking apparatus, comprising:
a housing, including a bottom, side walls, and a top;
at least one processor having at least one memory housed therein;
a graphical user interface disposed on one of the side walls;
a plurality of dispensers disposed in a plurality of apertures on the top of the housing, wherein the plurality of dispensers is adapted to dispense a plurality of cooking ingredients; and
a cooking drawer slidably mounted to the housing;
a first cooking element disposed within the cooking drawer;
a first cooking vessel disposed on the first cooking element;
a second cooking element disposed within the cooking drawer; and
a second cooking vessel disposed on the second cooking element.

2. The autonomous cooking apparatus of claim 1, further comprising:
a strainer tool hingedly mounted to the first cooking vessel, the strainer tool having a first position disposed within the first cooking vessel and a second position operative to discharge a content of the strainer tool into the second cooking vessel.

3. The autonomous cooking apparatus of claim 1, further comprising:
a stirring tool disposed on the second cooking vessel.

4. The autonomous cooking apparatus of claim 1, further comprising:
a conveyor tool operative to travel between a first subset of the plurality of dispensers to receive a portion of contents of the first subset of the plurality of dispensers and to discharge the portion of the contents into the second cooking vessel.

5. The autonomous cooking apparatus of claim 1, further comprising a lid removably mounted on each of the plurality of dispensers.

6. The autonomous cooking apparatus of claim 1, wherein the plurality of dispensers are each configured to contain a distinct cooking ingredient.

7. The autonomous cooking apparatus of claim 1, further comprising a dispensing means coupled to each of the plurality of dispensers.

8. An autonomous cooking system, comprising:
the autonomous cooking apparatus of claim 1, further comprising:
a strainer tool hingedly mounted to the first cooking vessel, the strainer tool having a first position disposed within the first cooking vessel and a second position operative to discharge a content of the strainer tool into the second cooking vessel; and
a stirring tool disposed on the second cooking vessel;
wherein the at least one memory stores instructions, that when executed by the processor cause a unidirectional cooking method to be performed, the unidirectional cooking method comprising:
receiving, from the graphical user interface or from a computing device, a selection of a recipe;
translating, by the processor, the recipe into at least one machine executable instruction to operate the autonomous cooking apparatus; and
actuating, by the processor, a component selected from the group consisting of one or more of the plurality of dispensers, the first cooking element, the second cooking element, the strainer tool, the stirring tool, and any combination thereof.
